(19) United States
(12) Patent Application Publication
(10) Pub. No.: US 2017/0182936 A1
(43) Pub. Date: Jun. 29, 2017

(54) INFORMATION PROVIDING APPARATUS

(71) Applicants: DENSO CORPORATION, Kariya-city, Aichi-pref. (JP); Fuji Heavy Industries Ltd., Shibuya-ku, Tokyo (JP)

(72) Inventors: Takaya KAWAMATA, Kariya-city (JP); Akifumi SHII, Kariya-city (JP); Kensuke SUZUKI, Kariya-city (JP); Toshiya FURUKAWA, Tokyo (JP); Tsukasa MIKUNI, Tokyo (JP); Isamu NAGASAWA, Tokyo (JP)

(73) Assignee: DENSO CORPORATION, Kariya-city, Aichi-pref. (JP)

(21) Appl. No.: 15/316,286

(22) PCT Filed: Sep. 8, 2015
(86) PCT No.: PCT/JP2015/004563

§ 371 Date: Dec. 5, 2016

(30) Foreign Application Priority Data
Sep. 26, 2014 (JP) 2014-196734

(51) Int. Cl. B60Q 3/20; B60Q 3/78; B60Q 3/74; B60R 21/015; B60Q 3/66; B60R 13/02; B60Q 1/14; G08B 21/22; B60Q 3/217; B60Q 3/18

(52) U.S. Cl. CPC B60Q 3/20; B60Q 3/217; B60Q 3/78; B60Q 3/74; B60Q 3/18; B60Q 3/66; B60R 13/02; B60Q 1/143; G08B 21/22; B60R 21/01538; B60Q 3/70

(57) ABSTRACT

An information providing apparatus in a vehicle cooperates with a light emitting unit including light emitting elements that are arranged in at least one string line on a vehicle-interior side of a door of the vehicle. The information providing apparatus includes an information acquisition section and a light emitting control section. The information acquisition section acquires repeatedly situation information including a peripheral situation that indicates a situation on a peripheral region surrounding the vehicle. The light emitting control section controls the light emitting unit based on the situation information acquired by the information acquisition section. The light emitting control section controls the light emitting unit so that the light emitting unit emits light in a light emitting mode associated with an acquired peripheral situation that is the peripheral situation indicated by the situation information acquired by the information acquisition section.

### CROSS REFERENCE TO RELATED APPLICATION

The present application is based on Japanese Patent Application No. 2014-196734 filed on Sep. 26, 2014, the disclosure of which is incorporated herein by reference.

### TECHNICAL FIELD

The present disclosure relates to an information providing apparatus in a vehicle.

### BACKGROUND ART

There is conventionally known in an automobile a lighting apparatus that includes a light source, a bar-shaped light guide body having a light scattering area, and a control unit controlling the light source to increase the intensity of light if an occupant is sitting on a seat of the vehicle (refer to Patent literature 1). The bar-shaped guide body is a cylindrical member that has rectangle-shaped holes passing light with intervals as a light scattering area.

### PRIOR ART LITERATURES

### Patent Literature

Patent literature 1: JP 2009-126193 A

### SUMMARY OF INVENTION

Improving a traveling safety for a vehicle requires providing of a situation on a peripheral region surrounding the vehicle to an occupant of the vehicle.

The lighting apparatus in Patent literature 1 only controls the intensity of light emitted by the light source depending on the presence or absence of an occupant sitting on a seat of the vehicle.

It is an object of the present disclosure to provide an information providing apparatus enabled to provide a situation in a peripheral region surrounding a vehicle.

To achieve the above object, according to an example of the present disclosure, an information providing apparatus in a vehicle is provided to include an information acquisition section and a light emitting control section. The information acquisition section acquires repeatedly situation information including a peripheral situation indicating a situation on a peripheral region surrounding the vehicle. The light emitting control section controls the light emitting unit so that the light emitting unit emits light in a light emitting mode associated with an acquired peripheral situation that is the peripheral situation indicated by the situation information acquired by the information acquisition section. The light emitting unit includes several light emitting elements that are arrayed in at least one string line on a vehicle-interior side of a door of the vehicle.

Such an information providing apparatus permits the light emitting unit to emit light in different modes according to respective peripheral situations, providing the situation on the peripheral region surrounding the vehicle. This allows an occupant to recognize the situation on the peripheral region surrounding the vehicle.

### BRIEF DESCRIPTION OF DRAWINGS

The above and other objects, features and advantages of the present disclosure will become more apparent from the following detailed description made with reference to the accompanying drawings. In the drawings:

FIG. 1 is a block diagram for explaining a schematic configuration of an information providing apparatus according to an embodiment to which the present disclosure is applied;

FIG. 2 is a diagram for explaining a configuration of a light emitting unit included in the information providing apparatus;

FIG. 3 is a diagram for explaining a light emitting substrate;

FIG. 4 is a diagram illustrating arrangement positions of light emitting units according to the embodiment;

FIG. 5 is a diagram illustrating an arrangement position of a light emitting unit according to the embodiment;

FIG. 6 is a flowchart diagram illustrating a sequence of an information providing process;

FIG. 7 is a flowchart diagram illustrating a sequence of a second light emitting process;

FIG. 8 is a flowchart diagram illustrating a sequence of a third light emitting process;

FIG. 9 is a diagram illustrating a specific example of a third light emitting mode;

FIG. 10 is a diagram illustrating a specific example of a third light emitting mode;

FIG. 11 is a diagram illustrating a specific example of a third light emitting mode;

FIG. 12 is a diagram illustrating a specific example of a third light emitting mode;

FIG. 13 is a diagram illustrating a specific example of a third light emitting mode;

FIG. 14 is a diagram illustrating a specific example of a third light emitting mode;

FIG. 15 is a flowchart diagram illustrating a sequence of a first light emitting process;

FIG. 16 is a diagram illustrating a modification example of an arrangement of the light emitting unit;

FIG. 17 is a diagram for explaining a modification example of the light emitting substrate;

FIG. 18 is a diagram illustrating an example of a light emitting mode according to a modification example; and

FIG. 19 is a diagram illustrating a modification example of a third light emitting mode.

### EMBODIMENTS FOR CARRYING OUT INVENTION

The following explains an embodiment of the present disclosure with reference to the drawings.

<Information Providing Apparatus>

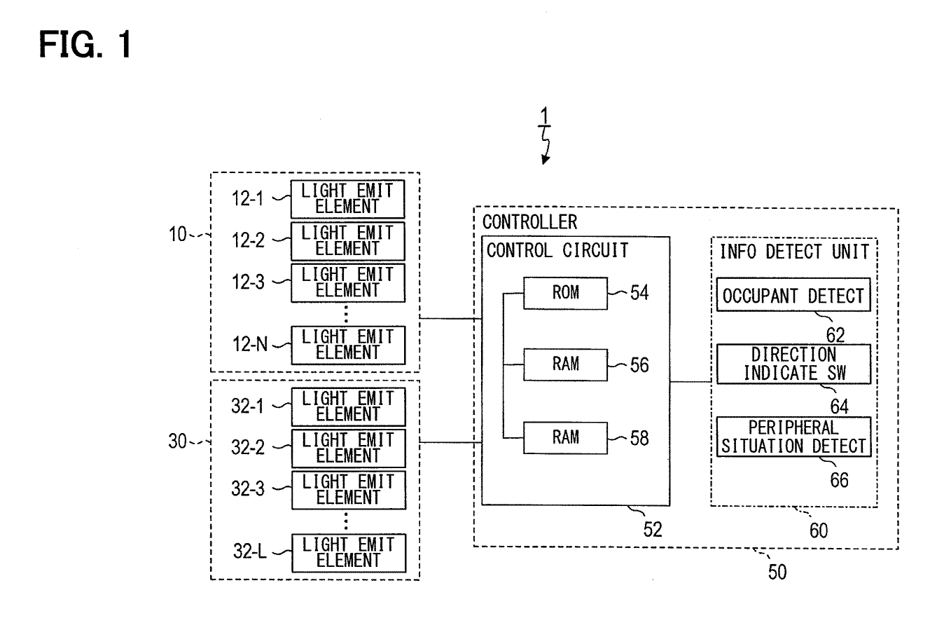

An information providing apparatus 1 illustrated in FIG. 1 is mounted in an automobile as a vehicle, which may be also referred to as a host vehicle.

The information providing apparatus 1 includes light emitting units 10, 30 and a controller 50 (which may be also referred to as an electronic control unit or a control system), providing an occupant with a variety of information by controlling light emitting modes in the light emitting units 10, 30. It is noted that “information” may be used not only as an uncountable noun but also a countable noun.

The light emitting unit 10 includes several light emitting elements 12-1 to 12-N that each emit light according to control signals from the controller 50. The light emitting elements 12-1 to 12-N in the light emitting unit 10 are arrayed to be formed as at least one string line on a vehicle-interior side of a door adjacent to a driver seat of the vehicle. Here, the sign “N” identifies the respective light emitting elements 12, and indicates the number of the light emitting elements 12.

The light emitting unit 30 includes several light emitting elements 32-1 to 32-N that each emit light according to control signals from the controller 50. The light emitting elements 32-1 to 32-L in the light emitting unit 30 are arrayed to be formed as at least one string line on a vehicle-interior side of a door adjacent to a front-passenger seat of the vehicle. Here, the sign “L” identifies the respective light emitting elements 32, and indicates the number of the light emitting elements 32. In the present embodiment, the number of the light emitting elements 32 may be equal to or different from the number of the light emitting elements 12.

<Configuration of Light Emitting Unit>The following explains configurations of the light emitting units 10, 30.

The light emitting unit 10 and the light emitting unit 30 are similar to each other except that they are different from each other in arrangement positions. The embodiment thus explains mainly the configuration of the light emitting unit 10 while omitting the explanation of the light emitting unit 30 by attaching reference signs of the components in the light emitting unit 30 to the corresponding components in the light emitting unit 10 to be inside of the parentheses behind the components in the light emitting unit 10.

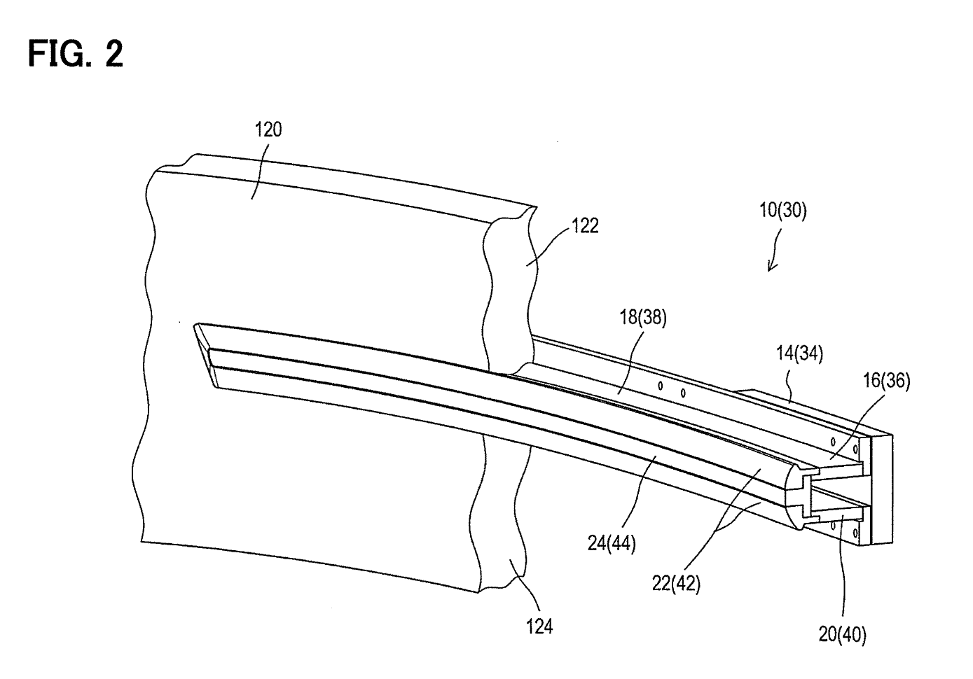

As in FIG. 2, the light emitting unit 10 (30), which includes a housing 16 (36), a bezel 22 (42), a lens 24 (44), and a light emitting substrate 14 (34), is formed in a long shape as a whole.

The housing 16 (36), which is a member accommodating several light emitting elements 12 (32), includes a first wall portion 18 (38) and a second wall portion 20 (40). The first wall portion 18 (38) and the second wall portion 20 (40) are arranged to have a gap therebetween. The lens 24 (44) is a member that collects and emanates the light from the light emitting elements 12 (32). The bezel 22 (42) is a member that holds the lens 24 (44) into the housing 16 (36).

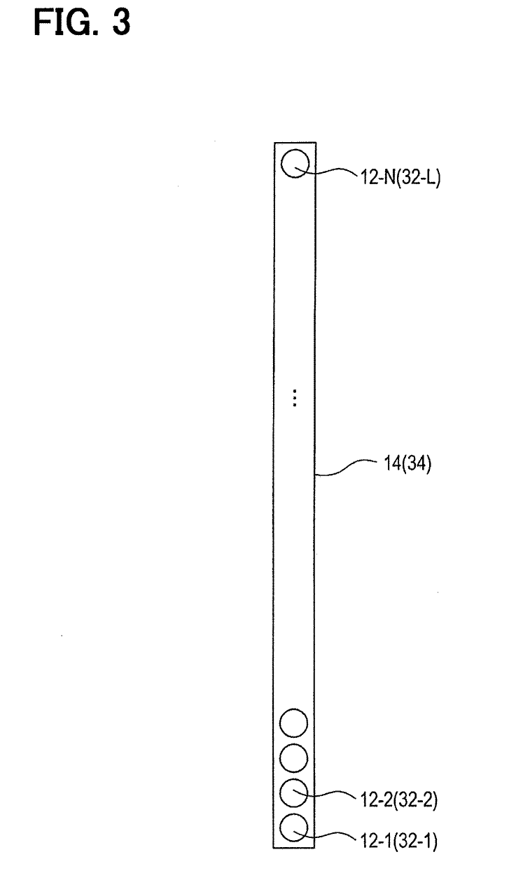

The light emitting substrate 14 (34) in the present embodiment is a substrate formed in a long shape, as in FIG. 3. The light emitting substrate 14 (34) has a front surface on which the light emitting elements 12 (32) are arrayed in at least one string line.

The light emitting element 12 (32) in the present embodiment is a light emitting diode. The light emitting diode is a known one that can emit three primary colors of light. Without need to be limited to the light emitting diode, the light emitting element in the present disclosure may be another light emitting source such as an organic electroluminescence or an electric bulb.

<Arrangement of Light Emitting Unit>

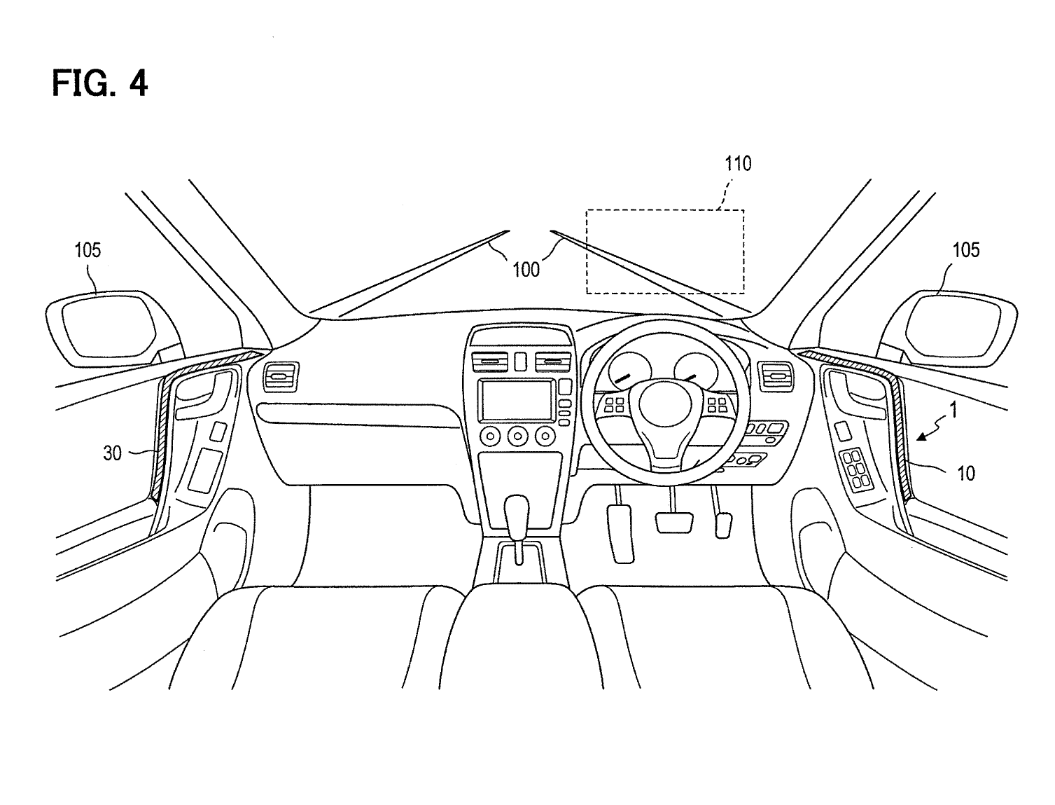

As in FIG. 4, the light emitting unit 10, 30 is arranged on a vehicle interior side of a front door of the automobile as being extended from a rear portion of the vehicle towards an eye-catching target being a specified target. The front door includes a driver-seat-side door provided on the side of the driver seat, while a front-passenger-seat-side door provided on the side of the front passenger seat. In particular, the light emitting unit 10 is arranged at the door on the side of the driver seat; the light emitting unit 30 is arranged at the door on the side of the front-passenger seat.

The eye-catching target is a target that the driver of the automobile is preferred to visually recognize during driving the automobile. The eye-catching target includes a “line marked on road” 100, a rearview mirror 105 provided to the vehicle, and a projection portion 110 on which images from a head up display mounted in the vehicle are projected. Here, the “line marked on road” 100, which is drawn on a road, corresponds to a mark presenting regulations or instructions on traffic on the road. The “line marked on road” includes a center line in a vehicle road, a lane line, or an outer line in a vehicle road.

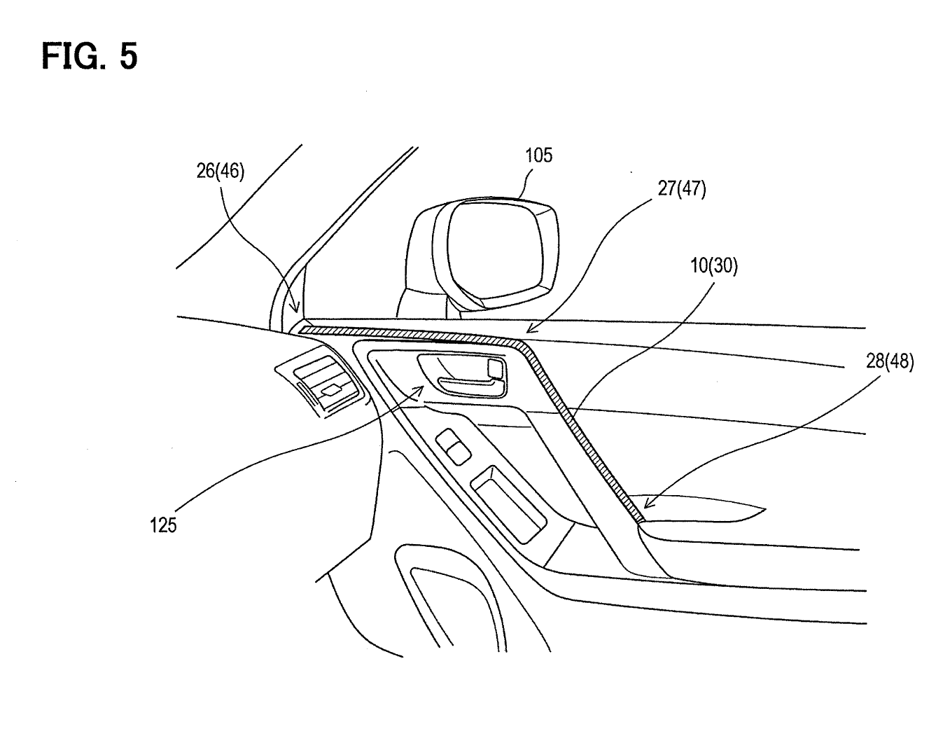

Furthermore, as in FIG. 5, the present embodiment arranges the light emitting unit 10 (30) to be bent downward from a front portion to a rear portion of the vehicle. In particular, the front end 26 (46) is arranged to be adjacent to, of the front door, a region contacting an A pillar. Note that a general automobile has a rearview mirror 105 adjacent to, of the front door, a region contacting the A pillar. In addition, the projection portion 110, on which images from the head-up display are projected, is formed on a region on the driver-seat side of the windshield of the automobile.

The light emitting unit 10 (30) has a region from the front end 26 (46) to a knee point 27 (47) bent downward; the region is arranged to be along an upper end portion of a door panel. The region from the front end 26 (46) to the knee point 27 (47) is arranged to be viewable as a continuous line from the “line marked on road” 100 when the sight line from the eye-point of the driver sitting on the driver seat is directed to the “line marked on road” 100 serving as one of the eye-catching targets. Furthermore, the rear end 28 (48) of the light emitting unit 10 (30) is arranged at a front-side end in the full length direction of an arm rest provided in the front door.

Note that the present embodiment provides the light emitting unit 10 (30) such that the front end 26 (46) is arranged to be higher, in a vehicle height direction, than a door handle 125 in the front door of the vehicle. This is because the rearview mirror 105 or projection portion 110 as a typical eye-catching target is often arranged to be higher in the vehicle height direction than the door handle 125 of the vehicle so as to be located within a field of view of the driver who is driving the automobile.

In the embodiment, the front end 26 (46) corresponds to the vehicle forward end portion of the light emitting unit 10 (30); the front end (26 (46) includes the vehicle forward end portion of the light emitting elements 12 (32) that are arranged as a string line and included in the light emitting unit 10 (30). In contrast, the rear end 28 (48) corresponds to the vehicle rearward end portion of the light emitting unit 10 (30); the rear end 28 (48) includes the vehicle rearward end portion of the light emitting elements 12 (32) that are arranged as a string line and included in the light emitting unit 10 (30). For example, the present embodiment assigns the light emitting element 12 (32) located in the rear end 28 (48) with the reference sign “1”, and assigns the light emitting element located in the front end 26 (46) with the reference sign “N (“L”).”

Note that the light emitting unit 10 (30) is arranged to be sandwiched in between a first region 122 and a second region 124, which are different from each other but included in a door trim 120 of the vehicle-interior side of the front door (refer to FIG. 2). Here, “sandwiched” may be achieved such that the light emitting unit 10 (30) is sandwiched between more than one member included in the door trim 120, or such that the light emitting unit 10 (30) is inserted into a recessed portion provided in the door trim 120.

In addition, the present embodiment provides the light emitting elements 12 (32) included in the light emitting unit 10 (30) to be located inside of a vehicle-interior-side outer surface of the front door and to be separated from the vehicle-interior-side outer surface towards the vehicle-exterior side.

<Controller>

The controller 50 in the information providing apparatus 1 includes a control circuit 52 and an information detection unit 60 (refer to FIG. 1).

The information detection unit 60, which may be referred to as an information acquisition unit, acquires a host vehicle situation indicating a situation of the vehicle itself (host vehicle) and a peripheral situation indicating a situation on a peripheral region surrounding the vehicle. The peripheral situation acquired by the information detection unit 60 may be also referred to as situation information (acquired peripheral situation).

The information detection unit 60 includes, as a mechanism acquiring a host vehicle situation, an occupant detection section 62 that acquires occupant information indicating the presence or absence of an occupant sitting on the front-passenger seat of the vehicle. The occupant detection section 62 in the present embodiment may be a mass meter installed in the front-passenger seat, or a camera that captures an image of a vehicle interior of the vehicle. The mass meter may be used to determine that an occupant is sitting on the front-passenger seat when the mass on the passenger seat is equal to or greater than a threshold value previously specified to a person's weight, providing the determination result as the occupant information.

The camera may be used to determine presence or absence of an occupant by capturing an image that is to be subjected to known image processing, providing the determination result as the occupant information.

In addition, the information detection unit 60 includes, as a mechanism acquiring the peripheral situation, a direction indication switch (SW) 64 that detects the status of a direction indicator provided in the vehicle, and a peripheral situation detection section 66 that detects a situation on a peripheral region surrounding the vehicle. The information detection unit 60 may include a known sensor or switch such as an ignition switch.

The information detection unit 60 in the present embodiment acquires the direction indication information expressing that the course that the vehicle is scheduled to travel is on the driver-seat side when the direction indication by the direction indication SW 64 exhibits the status on the driver-seat side. In contrast, the information detection unit 60 acquires the direction indication information expressing that the course that the vehicle is scheduled to travel is on the front-passenger-seat side when the direction indication by the direction indication SW 64 exhibits the status on the front-passenger-seat side. Further, the information detection unit 60 acquires the direction indication information expressing that the course that the vehicle is scheduled to travel is straight when the direction indication by the direction indication SW 64 exhibits neither the status on the driver-seat side nor the status on the front-passenger-seat side.

The peripheral situation detection section 66 in the present embodiment includes a camera that captures an image of a peripheral region surrounding the vehicle or a sensor apparatus that senses a situation on a peripheral region surrounding the vehicle. The camera acquires a specific object situation including the presence or absence of an object (which may be referred to as a specific object) such as an approaching vehicle in a peripheral region surrounding the vehicle based on the result from image processing for a captured image. In addition, the sensing apparatus detects a specific object situation including the presence or absence of a specific object based on the result of transmission and reception of search waves. The specific object situation includes a physical quantity of the specific object indicating the relative position between the specific object and the vehicle, the relative velocity between the vehicle and the specific object, and the magnitude of the specific object.

The control circuit 52 includes mainly a computer including a ROM 54, a RAM 56, and a CPU 68. The ROM 54 stores data and software programs constantly even if the power supply is disconnected. The RAM 56 stores temporarily data and software programs. The CPU 68 executes a variety of processes according to programs stored in the ROM 54 or RAM 56.

The ROM 54 stores a processing program for the control circuit 52 to execute an information providing process. The information providing process controls the light emitting unit 10, 30 (i.e., the light emitting elements 12-1 to 12-N, and the light emitting elements 32-1 to 32-L) to emit light according to the host vehicle situation or the peripheral situation acquired by the information detection unit 60 depending on light emitting modes associated with such situation.

<Information Providing Process>

The following explains an information providing process executed by the control circuit 52. The information providing process is repeatedly started with predetermined intervals of time.

It is further noted that a flowchart or processing of the process in the present disclosure includes sections (also referred to as steps), which are represented, for instance, as S110. Further, each section can be divided into several sections while several sections can be combined into a single section. Furthermore, each section can be referred to as a device or module. Further, each section or combined sections can be achieved not only (i) as a software section in combination with a hardware unit (e.g., computer), but also (ii) as a hardware section (e.g., integrated circuit, hard-wired logic circuit), including or not including a function of a related apparatus. Further, the hardware section may be inside of a microcomputer.

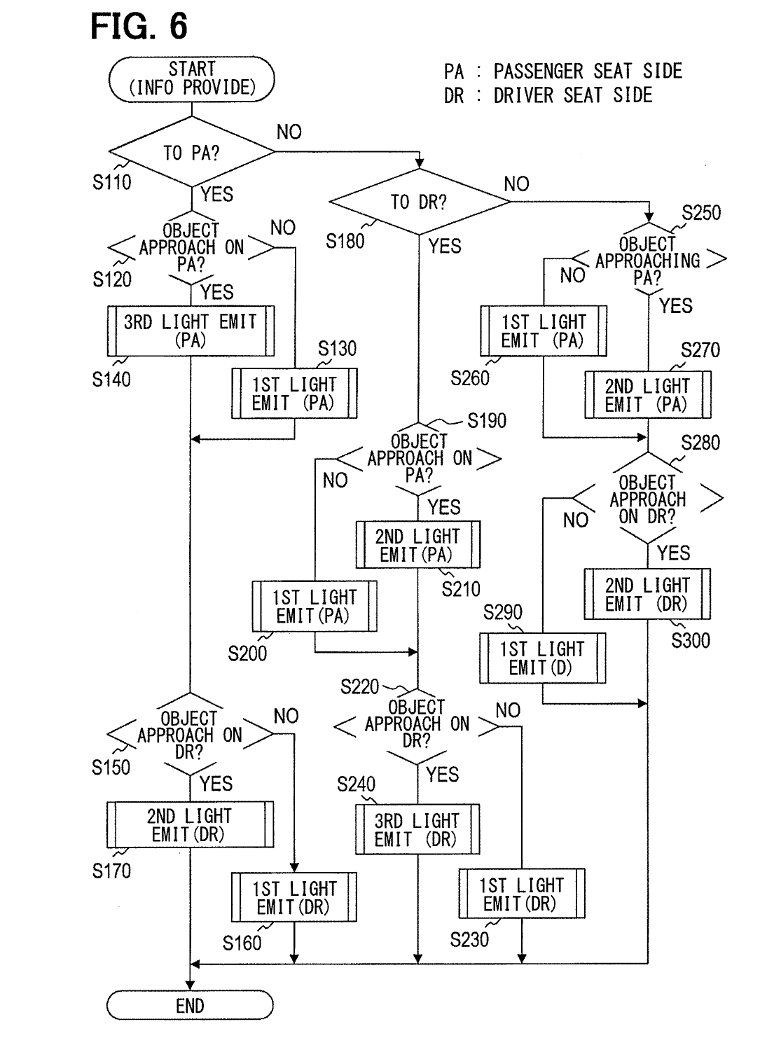

With the start of the information providing process as in FIG. 6, the control circuit 52 acquires direction indication information with the information detection unit 60, and determines the presence or absence of the schedule of the course change to the lane on the front-passenger-seat side based on the acquired direction indication information (S110). The control circuit 52 is in the present embodiment determines the schedule of the course change to the lane on the front-passenger-seat side when the direction indication information expresses that the course the vehicle is scheduled to travel is on the front-passenger-seat side.

When the schedule of the course change to the lane on the front-passenger-seat side is not determined (S110: NO), the control circuit 52 moves the information providing process to S180 mentioned later in detail. In contrast, when the schedule of the course change to the lane on the front-passenger-seat side is determined (S110: YES), the control circuit 52 moves the information providing process to S120. At S120, the control circuit 52 acquires the specific object situation from the peripheral situation detection section 66, and determined whether a specific object approaching the vehicle (which will be referred to as a front-passenger-seat-side approaching object) such as an approaching vehicle is exiting on the front-passenger-seat side based on the acquired specific object situation. When any front-passenger-seat-side approaching object is not determined to be existing (S120: NO), the control circuit 52 executes a first light emitting process that controls as a control target the light emitting unit 30 to emit light in a first light emitting mode previously specified (S130). The first light emitting mode in the present embodiment causes all the light emitting elements 12, 32 arranged within a specified segment in the light emitting unit 10, 30 as a control target to continue emitting light in a first specified color (e.g., white). The first light emitting process will be explained later in detail.

The control circuit 52 then moves the information providing process to S150. When a front-passenger-seat-side approaching object is determined to be existing (S120: YES), the control circuit 52 executes a third light emitting process that controls as a control target the light emitting unit 30 to emit light in a third light emitting mode previously specified (S140). The third light emitting mode in the present embodiment causes the light emitting elements 12, 32 in the light emitting unit 10, 30 as a control target to emit light in a second specified color (e.g., red) different from the first specified color while the light emitting elements 12, 32 are switched serially therebetween in an order of the arrangement. The third light emitting process will be explained later in detail.

The control circuit 52 then moves the information providing process to S150. At S150, it is determined whether a specific object approaching the vehicle (which will be referred to as a driver-seat-side approaching object) such as an approaching vehicle is existing on the driver-seat side based on the specific object situation acquired at s120. When any driver-seat-side approaching object is not determined to be existing (S150: NO), the control circuit 52 executes the first light emitting process that controls the light emitting unit 10 as a control target (S160).

The control circuit 52 then ends the information providing process, and stands by until the following activation point of time. In contrast, when a driver-seat-side approaching object is determined to be existing (S150: YES), the control circuit 52 executes a second light emitting process that controls as a control target the light emitting unit 10 to emit light in a second light emitting mode previously specified (S170). The second light emitting mode in the present embodiment causes all the light emitting elements 12, 32 arranged within a specified segment in the light emitting unit 10, 30 as a control target to continue emitting light in a third specified color different from the first specified color. The second light emitting process will be explained later in detail. The third specified color may be identical to or different from the second specified color.

The control circuit 52 then ends the information providing process, and stands by until the following activation point of time. At S180 taking place when the schedule of the course change to the lane on the front-passenger-seat side is not determined (S110: NO), the control circuit 52 determines the presence or absence of the schedule of the course change to the lane on the driver-seat side based on the direction indication information acquired at S110. In the present embodiment, the control circuit 52 determines the schedule of the course change to the lane on the driver-seat side when the direction indication information expresses that the course the vehicle is scheduled to travel is on the driver-seat side.

When the schedule of the course change to the lane on the driver-seat side is not determined (S180: NO), the control circuit 52 moves the information providing process to S250 mentioned later in detail. In contrast, when the schedule of the course change to the lane on the driver-seat side is determined (S180: YES), the control circuit 52 moves the information providing process to S190. At S190, the control circuit 52 acquires the specific object situation from the peripheral situation detection section 66, and determines whether a front-passenger-seat-side approaching object is existing based on the acquired specific object situation. When any front-passenger-seat-side approaching object is not determined to be existing (S190: NO), the control circuit 52 executes the first light emitting process that controls the light emitting unit 30 as a control target (S200). The control circuit 52 then moves the information providing process to S220.

In contrast, when a front-passenger-seat-side approaching object is determined to be existing (S190: YES), the control circuit 52 executes the second light emitting process that controls the light emitting unit 30 as a control target (S210). The control circuit 52 then moves the information providing process to S220.

At S220, it is determined whether a driver-seat-side approaching object is existing based on the specific object situation acquired at S190. When any driver-seat-side approaching object is not determined to be existing (S220: NO), the control circuit 52 executes the first light emitting process that controls the light emitting unit 10 as a control target (S230). The control circuit 52 then ends the information providing process, and stands by until the following activation point of time.

In contrast, when a driver-seat-side approaching object is determined to be existing (S220: YES), the control circuit 52 executes the third light emitting process that controls the light emitting unit 10 as a control target (S210). The control circuit 52 then ends the information providing process, and stands by until the following activation point of time.

At S250 taking place when the schedule of the course change to the lane on the driver-seat side is not determined to be existing (S180: NO), the control circuit 52 acquires the specific object situation from the peripheral situation detection section 66, and determines whether a front-passenger-seat-side approaching object is existing based on the acquired specific object situation. When any front-passenger-seat-side approaching object is not determined to be existing (S250: NO), the control circuit 52 executes the first light emitting process that controls the light emitting unit 10 as a control target (S260). The control circuit 52 then moves the information providing process to S280.

In contrast, when a front-passenger-seat-side approaching object is determined to be existing (S250: YES), the control circuit 52 executes the second light emitting process that controls the light emitting unit 30 as a control target (S270). The control circuit 52 then moves the information providing process to S280.

At S280, the control circuit 52 determines whether a driver-seat-side approaching object is existing based on the specific object situation acquired at S250. When any driver-seat-side approaching object is not determined to be existing (S280: NO), the control circuit 52 executes the first light emitting process that controls the light emitting unit 10 as a control target (S290). The control circuit 52 then ends the information providing process, and stands by until the following activation point of time.

In contrast, when a driver-seat-side approaching object is determined to be existing (S280: YES), the control circuit 52 executes the second light emitting process that controls the light emitting unit 10 as a control target (S300). The control circuit 52 then ends the information providing process, and stands by until the following activation point of time.

<Second Light Emitting Process>

The following explains the second light emitting process executed at S170, S210, S270, and S300 in the information providing process. In the second light emitting process under the present embodiment, a control target is switched between the light emitting unit 10 and the light emitting unit 30 depending on respective activation time points; however, the contents of the process is unchanged between the light emitting unit 10 and the light emitting unit 30. The second light emitting processes in both the light emitting unit 10 and the light emitting unit 30 will be explained in common.

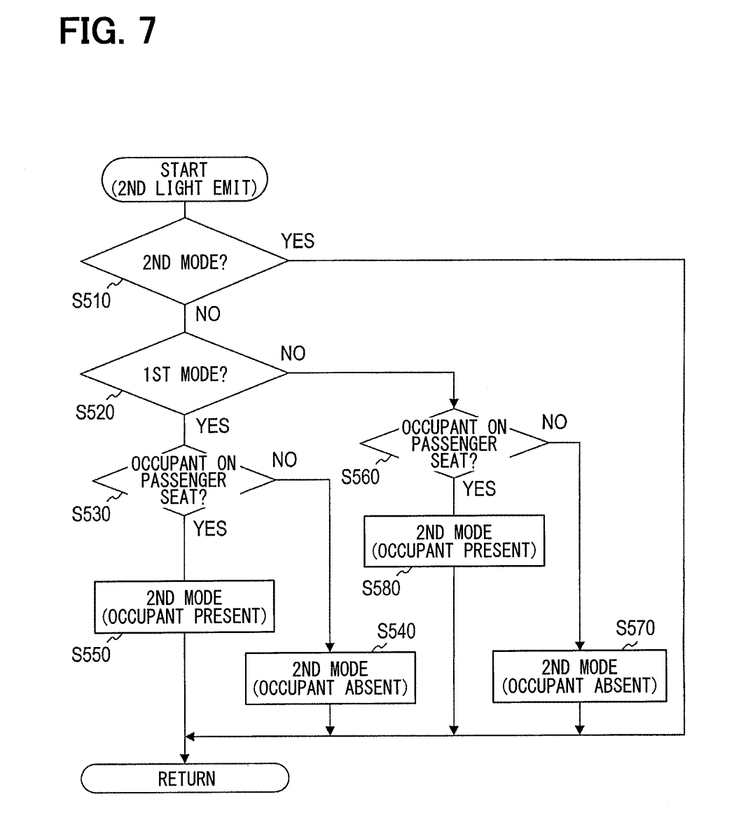

With the start of the second light emitting process as in FIG. 7, the control circuit 52 determines whether the light emitting mode at the present time in the control target (i.e., either the light emitting unit 10 or the light emitting unit 30) is the second light emitting mode (S510). The light emitting mode at the present time may be referred to as a present light emitting mode. When the present light emitting mode is determined to be the second light emitting mode (S510: YES), the control circuit 52 maintains the light emitting mode for the control target to be the second light emitting mode, ends the second light emitting process, returning the process to the information providing process.

In contrast, when the present light emitting mode is not determined to be the second light emitting mode (S510: NO), the control circuit 52 determines whether the present light emitting mode is the first light emitting mode (S520). When the present light emitting mode is not determined to be the first light emitting mode (S510: NO), i.e., when the present light emitting mode is the third light emitting mode, the control circuit 52 moves the second light emitting process to S560 mentioned later in detail.

When the present light emitting mode is determined to be the first light emitting mode (S520: YES), the control circuit 52 moves the second light emitting process to S530. At S530, the control circuit 52 acquires the occupant information from the occupant detection section 62, and determines whether the occupant is sitting on the front-passenger seat based on the acquired occupant information.

When any occupant is not determined to be sitting on the front-passenger seat (S530: NO), the control circuit 52 controls the control target to emit light in an occupant-absent mode of the second light emitting mode (S540). In the occupant-absent mode in the second light emitting mode according to the present embodiment, the control circuit 52 controls the control target so that all the light emitting elements 12, 32 arranged within a specified segment from the front end 26, 46 to the knee point 27, 47 to emit light in a third specified color. The control circuit 52 then ends the present second light emitting process, returning the process to the information providing process.

In contrast, when an occupant is determined to be sitting on the front-passenger seat (S530: YES), the control circuit 52 controls the light emitting unit 10 or the light emitting unit 30 to emit light in an occupant-present mode in the second light emitting mode (S550). In the occupant-present mode in the second light emitting mode according to the present embodiment, if the control target is the light emitting unit 30, a specified segment is turned into an occupant-present designated segment previously specified within the segment from the front end 46 to the knee point 47 in the control target, for instance. The control circuit 52 controls the light emitting unit 30 so that all the light emitting elements 32 arranged in the occupant-present designated segment emit light in the third specified color.

In contrast, if the control target is the light emitting unit 10, the control circuit 52 may control all the light emitting elements 12 arranged within a specified segment from the front end 26 to the knee point 27 to emit light in a third specified color, similarly to the occupant-absent mode. There is no need to be limited thereto. If the control target is the light emitting unit 10, the control circuit 52 may control all the light emitting elements 12 arranged within the occupant-present designated segment to emit light in the third specified color, similarly to the occupant-present mode. The occupant-present designated segment may correspond to a segment within a field of view during driving from the eye-point in the driver seat of the vehicle, i.e., either the whole of the segment from the front end 46 (26) to the knee point 47 (27), or a part of the segment from the front end 46 (27).

The control circuit 52 then ends the present second light emitting process, returning the process to the information providing process. At S560 taking place when the present light emitting mode is not the first light emitting mode (S520: NO), the control circuit 52 acquires the occupant information from the occupant detection section 62, and determines whether the occupant is sitting on the front-passenger seat based on the acquired occupant information.

When any occupant is not determined to be sitting on the front-passenger seat (S560: NO), the control circuit 52 controls the control target to emit light in an occupant-absent mode of the second light emitting mode (S570). The control circuit 52 then ends the present second light emitting process, returning the process to the information providing process.

In contrast, when an occupant is determined to be sitting on the front-passenger seat (S560: YES), the control circuit 52 controls the control target to emit light in the occupant-present mode in the second light emitting mode (S580). The control circuit 52 then ends the present second light emitting process, returning the process to the information providing process.

<Third Light Emitting Process>

The following explains the third light emitting process executed at S140 and S240 of the information providing process. In the third light emitting process under the present embodiment, a control target is switched between the light emitting unit 10 and the light emitting unit 30 depending on respective activation time points; however, the contents of the process is unchanged between the light emitting unit 10 and the light emitting unit 30. The third light emitting process in the light emitting unit 10 and the light emitting unit 30 will be explained in common.

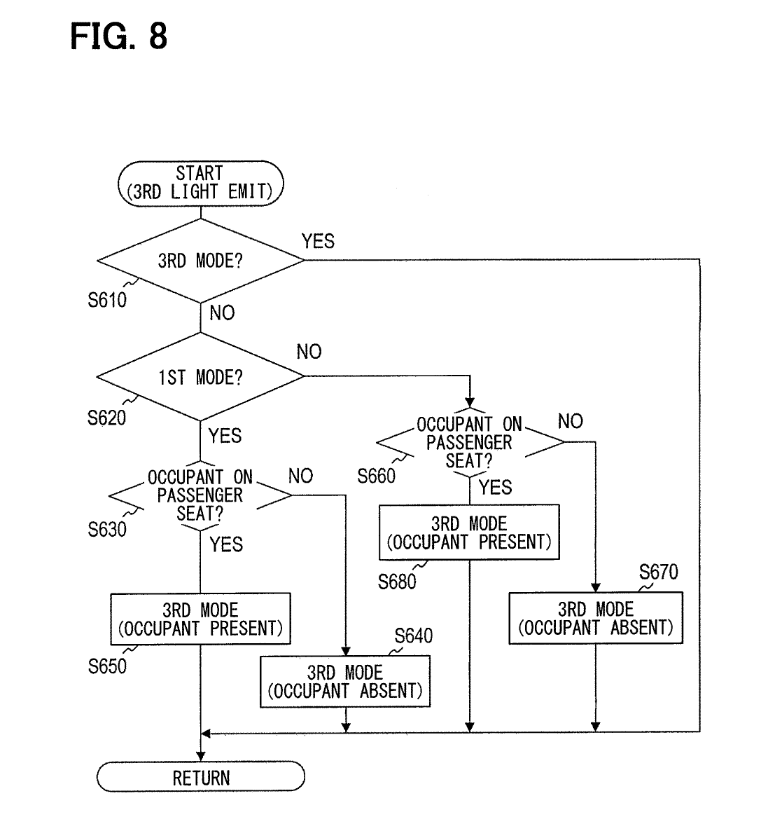

With the start of the third light emitting process as in FIG. 8, the control circuit 52 determines whether the present light emitting mode in the control target is the third light emitting mode (S610). When the present light emitting mode is determined to be the third light emitting mode (S610: YES), the control circuit 52 maintains the light emitting mode for the control target to be the third light emitting mode, ends the third light emitting process, returning the process to the information providing process.

In contrast, when the present light emitting mode is not determined to be the third light emitting mode (S610: NO), the control circuit 52 determines whether the present light emitting mode in the control target is the first light emitting mode (S620). When the present light emitting mode is not determined to be the first light emitting mode (S620: NO), i.e., when the present light emitting mode is the second light emitting mode, the control circuit 52 moves the third light emitting process to S660 mentioned later in detail.

When the present light emitting mode is determined to be the first light emitting mode (S620: YES), the control circuit 52 moves the third light emitting process to S630. At S630, the control circuit 52 acquires the occupant information from the occupant detection section 62, and determines whether the occupant is sitting on the front-passenger seat based on the acquired occupant information.

When any occupant is not determined to be sitting on the front-passenger seat (S630: NO), the control circuit 52 controls the control target to emit light in the occupant-absent mode in the third light emitting mode (S640).

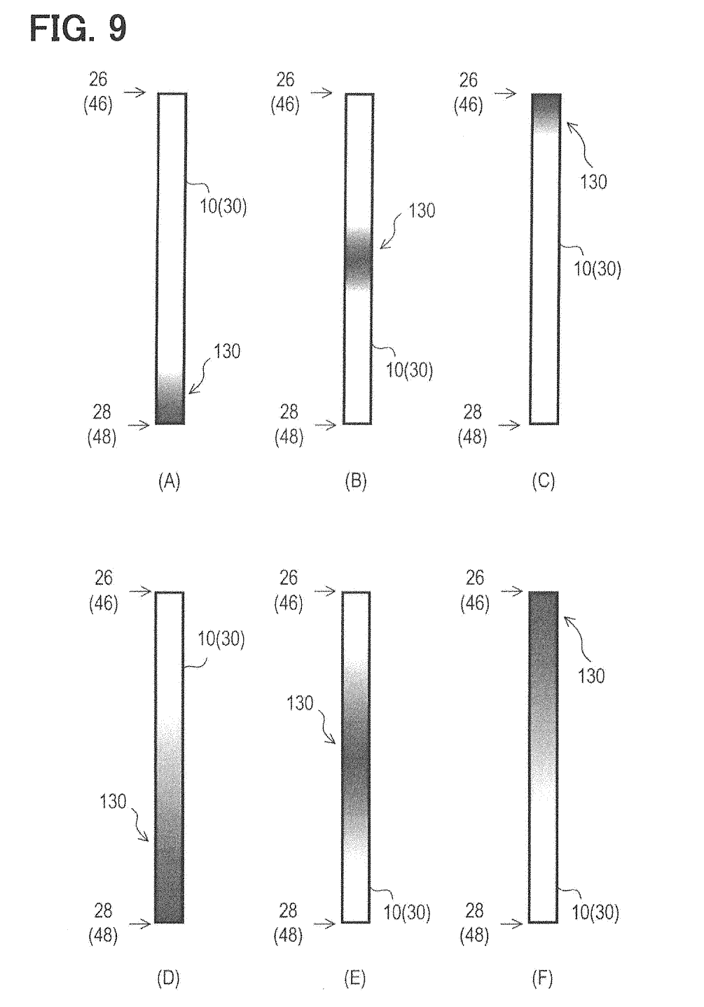

In the occupant-absent mode in the third light emitting mode according to the present embodiment, the control circuit 52 controls the light emitting elements 12, 32 in the control target to emit light in a second specified color while the light emitting elements 12, 32 are serially switched therebetween in an order of the arrangement. In the present embodiment, the light emitting element(s) switched therebetween serially while emitting light in the second specified color may be referred to as a light emitting target 130, see FIGS. 9 to 14. The light emitting target is a group of light emitting elements 12, 32 continuously arranged. Without need to be limited thererto, the light emitting target 130 may be a single light emitting element 12, 32, or a specific arrangement pattern by several light emitting elements 12, 32.

Furthermore, the present embodiment may change the light emitting state of the light emitting target 130 in the control target depending on a specific physical quantity of a specific object. Here, “light emitting state” includes turning on or turning off of the light emitting elements 12, 32, the number of the light emitting elements 12, 32 that are turned on or off, or a parameter of light emitting of the light emitting elements 12, 32 turned on such as an intensity, a color, or an interval of time.

Changing the light emitting state depending on a physical quantity of a specific object may be exemplified by changing the number (which may be referred to as a constituents count) of the light emitting elements 12, 32 constituting the group of light emitting elements as a light emitting target depending on the magnitude of the specific object or the relative distance of the specific object with the vehicle. In particular, when the magnitude of a specific object is small, or when the relative distance is great, the constituents count is decreased as in (A), (B), (C) of FIG. 9. In contrast, when the magnitude of a specific object is great, or when the relative distance is small, the constituents count is increased as in (D), (E), (F) of FIG. 9. Note that (A), (B), and (C) of FIG. 9 illustrate the light emitting target 130 in time series when the magnitude of a specific object is small, or when the relative distance is great. In (A) of FIG. 9, the light emitting target 130 corresponds to the group of light emitting elements arranged adjacent to the rear end 28, 48. In (B) and (C) of FIG. 9, the light emitting target 130 moves towards the front end 26, 46 with the lapse of time. Further, (D), (E), and (F) of FIG. 9 illustrate the light emitting target in time series when the magnitude of a specific object is great, or when the relative distance is small. In (D) of FIG. 9, the light emitting target 130 corresponds to the group of light emitting elements arranged adjacent to the rear end 28, 48. In (E) and (F) of FIG. 9, the light emitting target 130 moves towards the front end 26, 46 with the lapse of time.

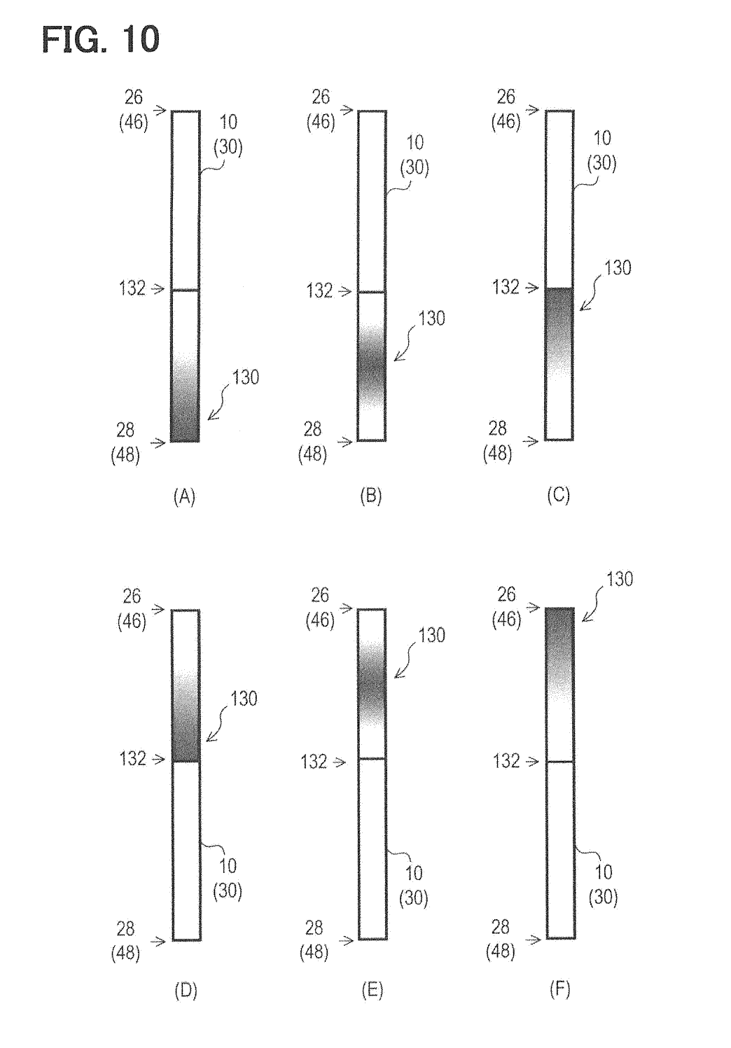

Changing the light emitting state depending on the relative position of a specific object with the vehicle may be exemplified by changing the position of the segment forming the light emitting target 130 within the whole of the segment of the light emitting elements 12, 32 from the front end 26, 46 to the rear end 28, 48. Under such cases, if the relative distance between the vehicle and the specific object is great, as in (A), (B), and (C) of FIG. 10, the light emitting target 130 is provided as the light emitting elements 12, 32 arranged within a segment from the rear end 28, 48 to a first specified position 132. In contrast, if the relative distance between the vehicle and the specific object is small, as in (D), (E), and (F) of FIG. 10, the light emitting target 130 is provided as the light emitting elements 12, 32 arranged within a segment from the first specified position 132 to the front end 26, 46. Note that (A), (B), and (C) of FIG. 10 illustrate the light emitting target 130 in time series when the relative distance is great. In (A) of FIG. 10, the light emitting target 130 corresponds to the group of light emitting elements arranged adjacent to the rear end 28, 48. In (B) and (C) of FIG. 10, the light emitting target 130 having the second specified color moves towards the first specified position 132 with the lapse of time. Further, (D), (E), and (F) of FIG. 10 illustrate the light emitting target in time series when the magnitude of a specific object is great, or when the relative distance is small. In (D) of FIG. 10, the light emitting target 130 corresponds to the group of light emitting elements arranged adjacent to the first specified position 132. In (E) and (F) of FIG. 10, the light emitting target 130 moves towards the front end 26, 46 with the lapse of time.

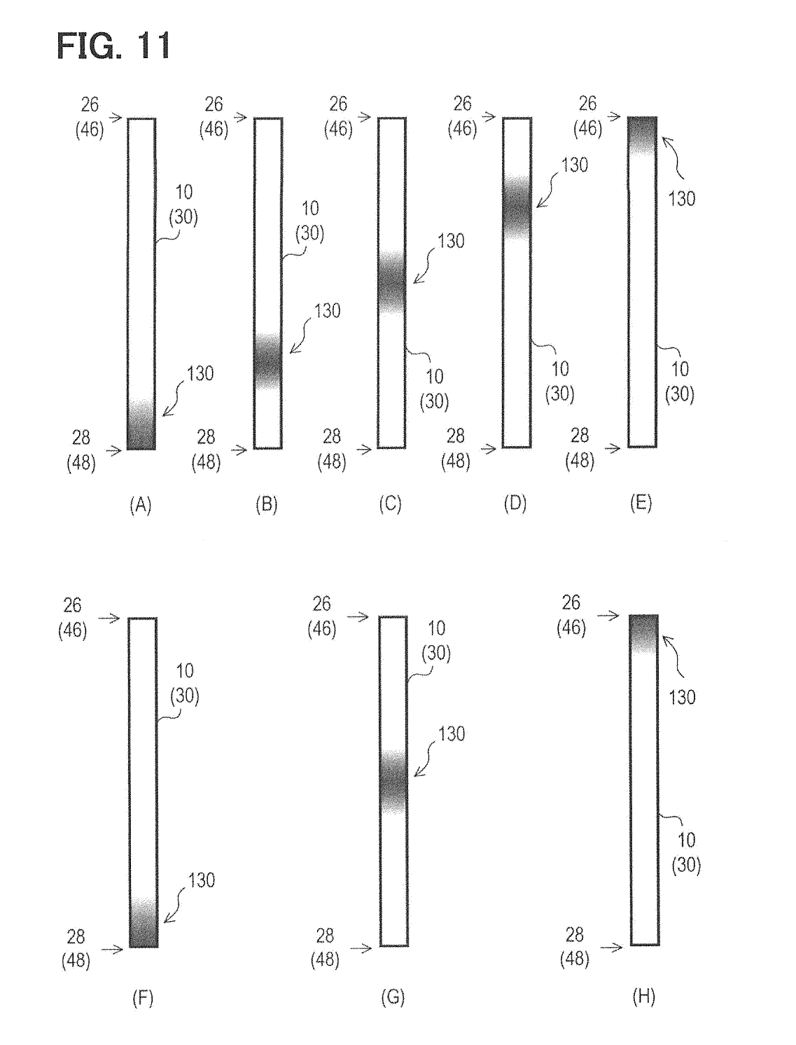

Further, changing the light emitting state depending on a physical quantity of a specific object may be exemplified by controlling the switching time of the light emitting target 130 depending on the velocity of the specific object. Under such cases, as the velocity of a specific object is smaller, a shift completion time that is a time length necessary for the light emitting target 130 to move from the rear end 28, 48 to the front end 26, 46 is greater, as in (A), (B), (C), (D), and (E) of FIG. 11. In contrast, as the velocity of a specific object is greater, the shift completion time is smaller, as in (D), (E), and (F) of FIG. 11. Note that (A) to (E) of FIG. 11 illustrate the light emitting target 130 in time series when the velocity of the specific object is small. In (A) of FIG. 11, the light emitting target 130 corresponds to the group of light emitting elements arranged adjacent to the rear end 28, 48. In (B) to (E) of FIG. 11, the light emitting target 130 moves towards the front end 26, 48 with the lapse of time. Note that (F), (G), and (H) of FIG. 11 illustrate the light emitting target 130 in time series when the velocity of the specific object is great. In (F) of FIG. 11, the light emitting target 130 corresponds to the group of light emitting elements arranged adjacent to the rear end 28, 48. In (G) and (H) of FIG. 11, the light emitting target 130 moves towards the front end 26, 46 with the lapse of time.

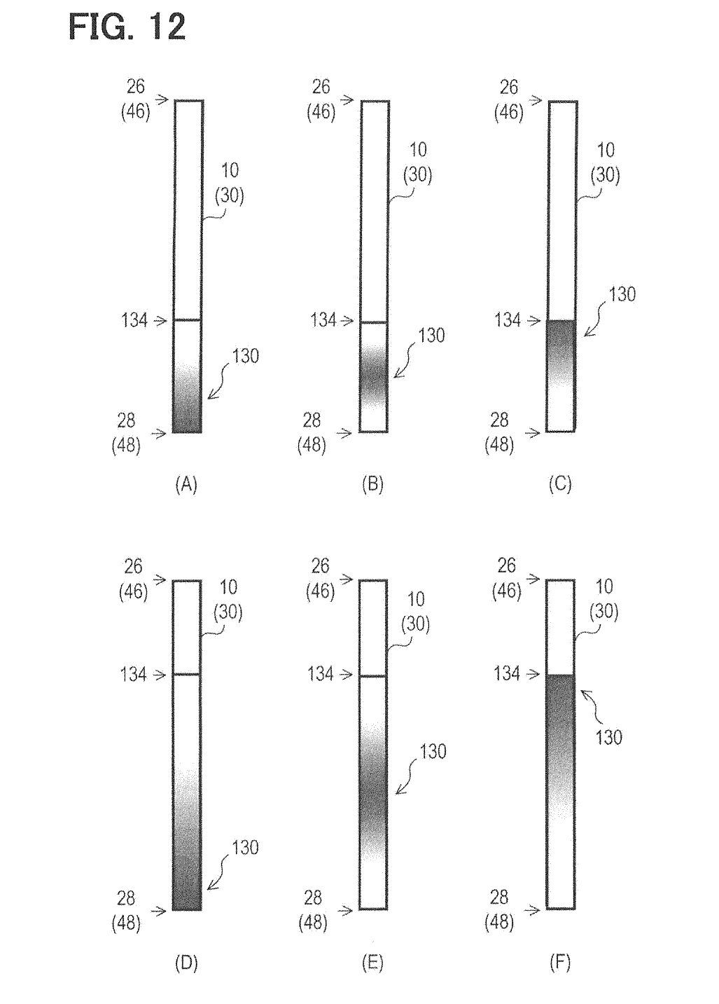

Further, changing the light emitting state depending on the velocity of a specific object with the vehicle may be exemplified by changing a last arrival point of the light emitting target 130 moving with the lapse of time. Under such cases, the last arrival point 134 is closer to the rear end 28, 48 as the velocity of the specific object is smaller, as in (A), (B), and (C) of FIG. 12. In contrast, the last arrival point 134 is farther from the rear end 28, 48 as the velocity of the specific object is greater, as in (D), (E), and (F) of FIG. 12. Note that (A) to (C) of FIG. 12 illustrate the light emitting target 130 in time series when the velocity of the specific object is small. In (A) of FIG. 12, the light emitting target 130 corresponds to the group of light emitting elements arranged adjacent to the rear end 28, 48. In (B) and (C) of FIG. 12, the light emitting target 130 moves towards the last arrival point 134 with the lapse of time. Note that (D), (E), and (F) of FIG. 12 illustrate the light emitting target 130 in time series when the velocity of the specific object is great. In (D) of FIG. 12, the light emitting target 130 corresponds to the group of light emitting elements arranged adjacent to the rear end 28, 48. In (E) and (F) of FIG. 12, the light emitting target 130 moves towards the last arrival point 134 with the lapse of time.

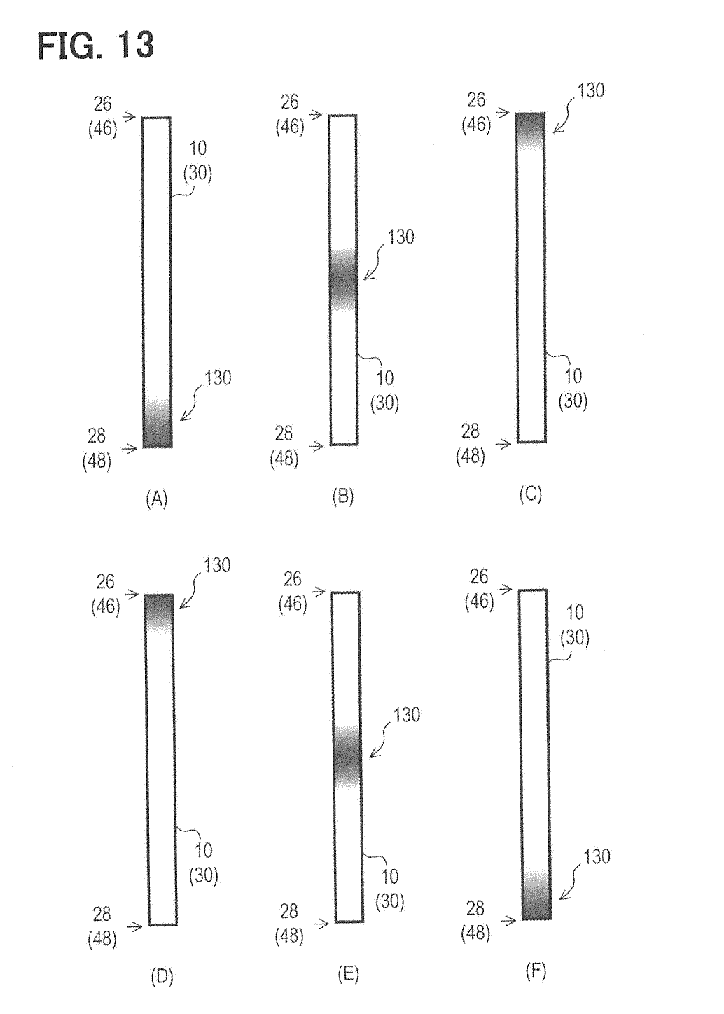

Further, changing the light emitting state depending on the velocity of a specific object with the vehicle may be exemplified by changing a moving direction of the light emitting target 130 moving with the lapse of time depending on the approaching direction of the specific object. Under such cases, when the approaching direction of the specific object is from the back of the vehicle, the moving direction of the light emitting target 130 is from the rear end 28, 48 to the front end 26, 46, as in (A), (B), and (C) of FIG. 13. In contrast, when the approaching direction of the specific object is from the front of the vehicle, the moving direction of the light emitting target 130 is from the front end 26, 46 to the rear end 28, 48, as in (D), (E), and (F) of FIG. 13. Note that (A) to (C) of FIG. 13 illustrate the light emitting target 130 in time series when the moving direction of the specific object is from the back of the vehicle. In (A) of FIG. 13, the light emitting target 130 corresponds to the group of light emitting elements arranged adjacent to the rear end 28, 48. In (B) and (C) of FIG. 13, the light emitting target 130 moves towards the front end 26, 46 with the lapse of time. Note that (D), (E), and (F) of FIG. 13 illustrate the light emitting target 130 in time series when the moving direction of the specific object is from the front of the vehicle. In (D) of FIG. 13, the light emitting target 130 corresponds to the group of light emitting elements arranged adjacent to the front end 26, 46. In (E) and (F) of FIG. 13, the light emitting target 130 moves towards the rear end 28, 48 with the lapse of time.

The control circuit 52 then ends the present third light emitting process, returning the process to the information providing process.

In contrast, when an occupant is determined to be sitting on the front-passenger seat (S630: YES), the control circuit 52 controls the control target to emit light in the occupant-present mode in the third light emitting mode (S650).

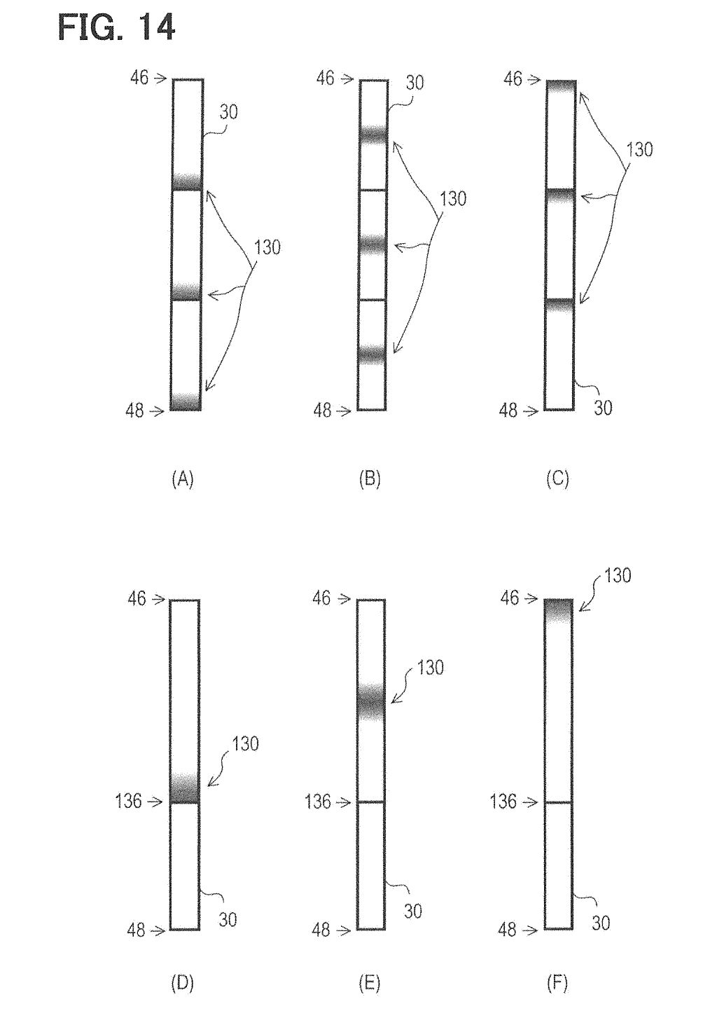

In the occupant-present mode of the third light emitting mode in the present embodiment, if the control target is the light emitting unit 30, the control circuit 52 controls the light emitting target 130 including the group of light emitting elements arranged in each of several segments into which the whole of the segment from the rear end 48 to the front end 46 is divided, as in (A), (B), and (C) of FIG. 14. The control circuit 52 controls each of the several light emitting targets 130 to emit light in a light emitting mode identical to the occupant-absent mode of the third light emitting mode.

Note that (A) to (C) of FIG. 14 illustrate the light emitting target 130 including the group of light emitting elements 32 arranged in each segment in time series. In (A) of FIG. 14, each of the light emitting targets 130 corresponds to the group of light emitting elements arranged closer to the rear end 48. In (B) and (C) of FIG. 14, each of the light emitting targets 130 moves towards the front end 46 with the lapse of time.

The light emitting target 130 in the occupant-present mode is not limited thereto. As in (D), (E), and (F) of FIG. 14, the light emitting target 130 may correspond to the group of the light emitting elements arranged in an occupant-present light emitting segment from the front end 46 to a second specified position 136. The occupant-present light emitting segment may correspond to a segment within a field of view during driving from the eye-point in the driver seat of the vehicle, i.e., either the whole of the segment from the front end 46 to the rear end 48, or the segment from the front end 46 to the second specified position 136.

Note that (D), (E), and (F) of FIG. 14 illustrate, in time series, the light emitting target 130 including the group of the light emitting elements 32 arranged in the occupant-present light emitting segment from the front end 46 to the second specified position 136. In (D) of FIG. 14, the light emitting target 130 corresponds to the group of light emitting elements arranged closer to the rear end 48. In (E) and (F) of FIG. 14, the light emitting target 130 moves towards the front end 46 with the lapse of time.

In contrast, if the control target is the light emitting unit 10, the occupant-present light emitting segment within the whole of the segment from the rear end 28 to the front end 26 may be subjected to a control similar to the occupant-absent mode, or the whole of the segment from the rear end 28 to the front end 26 may be subjected to a control similar to the occupant-absent mode. The occupant-present light emitting segment may correspond to a segment within a field of view during driving from the eye-point in the driver seat of the vehicle, i.e., either the whole of the segment from the front end 26 to the rear end 28, or the segment from the front end 26 to the second specified position 136.

The control circuit 52 then ends the present third light emitting process, returning the process to the information providing process.

At S660 taking place when the present light emitting mode in the control target is not the first light emitting mode (S620: NO), the control circuit 52 acquires the occupant information from the occupant detection section 62, and determines whether the occupant is sitting on the front-passenger seat based on the acquired occupant information.

When any occupant is not determined to be sitting on the front-passenger seat (S660: NO), the control circuit 52 controls the control target to emit light in the occupant-absent mode in the third light emitting mode (S670). The control circuit 52 then ends the present third light emitting process, returning the process to the information providing process.

In contrast, when an occupant is determined to be sitting on the front-passenger seat (S660: YES), the control circuit 52 controls the control target to emit light in the occupant-present mode in the third light emitting mode (S680). The control circuit 52 then ends the present third light emitting process, returning the process to the information providing process.

<First Light Emitting Process>

The following explains the first light emitting process executed at S130, S160, S200, S230, S260, and S300 in the information providing process. In the first light emitting process under the present embodiment, a control target is switched between the light emitting unit 10 and the light emitting unit 30 depending on respective activation time points; however, the contents of the process is unchanged between the light emitting unit 10 and the light emitting unit 30. The third light emitting process in the light emitting unit 10 and the light emitting unit 30 will be explained in common.

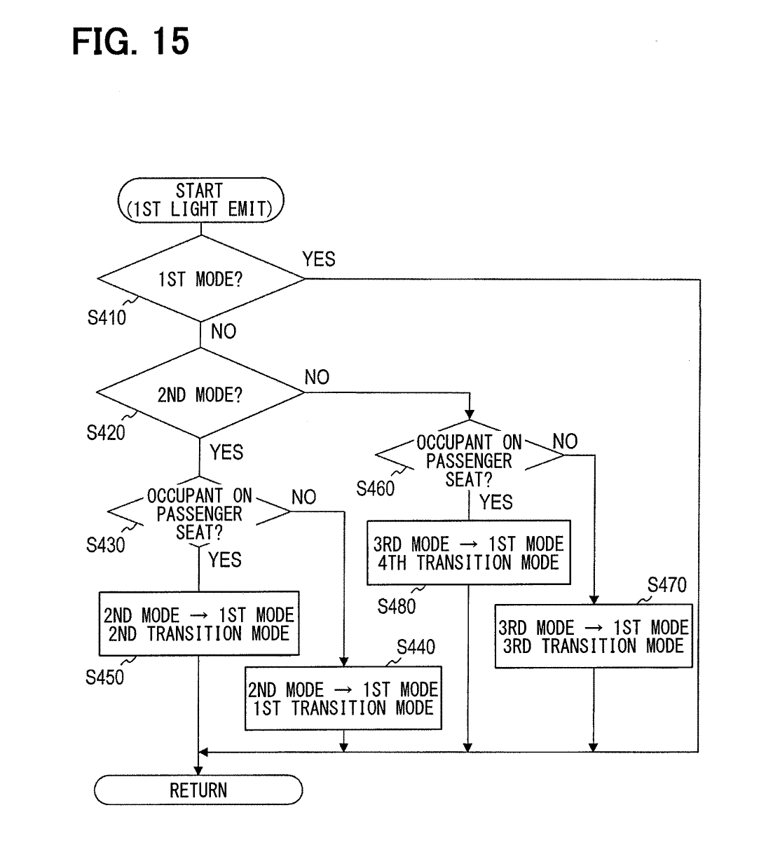

With the start of the first light emitting process as in FIG. 15, the control circuit 52 determines whether the present light emitting mode in the control target is the first light emitting mode (S410). When the present light emitting mode is determined to be the first light emitting mode (S410: YES), the control circuit 52 maintains the light emitting mode for the control target to be the first light emitting mode, ends the first light emitting process, returning the process to the information providing process.

In contrast, when the present light emitting mode is not determined to be the first light emitting mode (S410: NO), the control circuit 52 determines whether the present light emitting mode in the control target is the second light emitting mode (S420). When the present light emitting mode is not determined to be the second light emitting mode (S420: NO), i.e., when the present light emitting mode is the third light emitting mode, the control circuit 52 moves the first light emitting process to S460 mentioned later in detail.

When the present light emitting mode for the control target is determined to be the second light emitting mode (S420: YES), the control circuit 52 moves the first light emitting process to S430. At S430, the control circuit 52 acquires the occupant information from the occupant detection section 62, and determines whether the occupant is sitting on the front-passenger seat based on the acquired occupant information.

When any occupant is not determined to be sitting on the front-passenger seat (S430: NO), the control circuit 52 controls the control target to emit light in a first transition mode (S440). Such a first transition mode is one of modes that cause the light emitting mode in the control target to transition from the second light emitting mode to the first light emitting mode within a specified time of a time length previously specified. That is, the first transition mode in the present embodiment causes all the light emitting elements 12, 32 arranged within the specified segment in the light emitting unit 10, 30 as the control target to switch over the specified time in emitting light in a first specified color. Note that the specified segment may be either the segment from the front end 26, 46 to the knee point 27, 47, or the segment from the front end 26, 46 to the rear end 28, 48.

The control circuit 52 then ends the present first light emitting process, returning the process to the information providing process.

In contrast, when an occupant is determined to be sitting on the front-passenger seat (S430: YES), the control circuit 52 controls the light emitting unit 10 or the light emitting unit 30 to emit light in a second transition mode (S450). Such a second transition mode is one of modes that cause the light emitting mode in the control target to transition from the second light emitting mode to the first light emitting mode. That is, the second transition mode in the present embodiment causes all the light emitting elements 12, 32 arranged within the specified segment in the light emitting unit 10, 30 as the control target to switch over the specified time in emitting light in the first specified color.

The control circuit 52 then ends the present first light emitting process, returning the process to the information providing process.

At S460 taking place when the present light emitting mode is not the first light emitting mode (S420: NO), the control circuit 52 acquires the occupant information from the occupant detection section 62, and determines whether the occupant is sitting on the front-passenger seat based on the acquired occupant information.

When any occupant is not determined to be sitting on the front-passenger seat (S460: NO), the control circuit 52 controls the control target to emit light in a third transition mode (S470). Such a third transition mode is one of modes that cause the light emitting mode in the control target to transition from the third light emitting mode to the first light emitting mode. That is, the third transition mode in the present embodiment causes all the light emitting elements 12, 32 arranged within the specified segment in the light emitting unit 10, 30 as the control target to switch over the specified time in emitting light in a first specified color.

The control circuit 52 then ends the present first light emitting process, returning the process to the information providing process. In contrast, when an occupant is determined to be sitting on the front-passenger seat (S460: YES), the control circuit 52 controls the control target to emit light in a fourth transition mode (S480). Such a fourth transition mode is one of modes that cause the light emitting mode in the control target to transition from the third light emitting mode to the first light emitting mode. That is, the fourth transition mode in the present embodiment causes all the light emitting elements 12, 32 arranged within the specified segment in the light emitting unit 10, 30 as the control target to switch over the specified time in emitting light in a first specified color.

The control circuit 52 then ends the present first light emitting process, returning the process to the information providing process.

As mentioned above, the information providing process according to the present embodiment causes the light emitting unit 10, 30 to emit light in the first light emitting mode when a specific object approaching the vehicle does not exist, while causing the light emitting unit 30 on the side of the front-passenger seat to emit light in the second light emitting mode when a specific object approaching the vehicle exists on the side of the front-passenger seat. In contrast, the information providing process causes the light emitting unit 10 on the side of the driver seat to emit light in the second light emitting mode when a specific object approaching the vehicle exists on the side of the driver seat.

Furthermore, the information providing process causes the light emitting unit 10 (30) in a subject direction where a specific object exists to emit light in the third light emitting mode when the scheduled moving direction of the vehicle indicated by the direction indication information accords with the subject direction. That is, the light emitting unit 30 on the side of the front-passenger seat is caused to emit light in the third light emitting mode when the scheduled moving direction of the vehicle is on the side of the front-passenger seat under the state where the specific object is existing on the side of the front-passenger seat. In contrast, the light emitting unit 10 on the side of the driver seat is caused to emit light in the third light emitting mode when the scheduled moving direction of the vehicle is on the side of the driver seat under the state where the specific object is existing on the side of the driver seat.

Note that the information providing process may assign a light emitting control target in the light emitting unit 30 to each of divided segments or part of the divided segments when an occupant is seated on the front-passenger seat.

The control circuit 52 functions as an information acquisition section at S110, S120, S150, S180, S190, S250, and S280. In addition, it functions as a light emitting control section at S130, S140, S160, S170, S200, S210, S230, S240, S260, S270, S290, and S300. Furthermore, it functions as an occupant information acquisition section at S430, S460, S530, S560, S630, and S660.

### Effects of Embodiment

The information providing process according to the present embodiment assigns the light emitting mode of the light emitting unit 10, 30 with the first light emitting mode or the second light emitting mode depending on the presence or absence of a specific object. Furthermore, the information providing process assigns the light emitting mode of the light emitting unit 10, 30 with the third light emitting mode when a specific object is existing and, simultaneously, the direction indication information accords with the direction in which the vehicle approaches the specific object.

This allows the information providing apparatus 1 to provide the presence or absence of a specific object and, furthermore, the presence of the specific object existing on the lane the vehicle is scheduled to travel.

In other words, the information providing apparatus 1 allows the light emitting unit 10, 30 to emit light in different modes according to respective peripheral situations, providing the situation on the peripheral region surrounding the vehicle. The information providing apparatus 1 thus allows an occupant to recognize the situation on the peripheral region surrounding the vehicle.

In addition, the information providing process according to the present embodiment changes the light emitting states of the light emitting elements 12, 32 depending on the physical quantity of the specific object. This allows the information providing apparatus 1 to express the physical quantity of the specific object in the light emitting state, permitting the occupant to recognize the physical quantity of the specific object.

Furthermore, in the information providing process, the control target is assigned to the light emitting unit 10 provided in the door on the side of the driver seat when the specific object is existing on the lane on the side of the driver seat; the control target is assigned to the light emitting unit 30 provided in the door on the side of the front-passenger seat when the specific object is existing on the lane on the side of the front-passenger seat. The information providing apparatus 1 thus allows an occupant to recognize the presence of the specific object.

Furthermore, the information providing process assigns the light emitting target 130 to the group of the light emitting elements 12, 32 arranged within the occupant-present light emitting segment from the front end 46 to the second specified position 136. The occupant-present light emitting segment corresponds to a segment within a field of view during driving from the eye-point in the driver seat of the vehicle; the information providing apparatus 1 allows the driver to see the information provided by the light emitting unit 30 even when an occupant is seated on the front-passenger seat.

In addition, the information providing apparatus 1 arranges the front end 26, 46 to be higher, in the height direction of the vehicle, than the door handle 125 of the vehicle.

The information providing apparatus 1 allows the driver to see the light emitting elements 12, 32 in the light emitting unit 10, 30 emitting light, without significantly changing the sight line during driving. The information providing apparatus 1 can thus direct the driver's sight line to an eye-catching target with little movement.

### Other Embodiments

Up to this point, description has been given to an embodiment of the present disclosure. The present disclosure is not limited to the above embodiment, and it can be variously embodied as long as not departing from a scope of the present disclosure.

For instance, the above embodiment arranges the rear end 28 (48) of the light emitting unit 10, 30 at an end on the front side within the full length direction of an arm rest provided in the front door. The arrangement position of the rear end 28 (48) is not limited thereto. That is, the arrangement position of the rear end 28 (48) of the light emitting unit 10, 30 may be an end on the rear side in the full length direction in the whole of the front door.

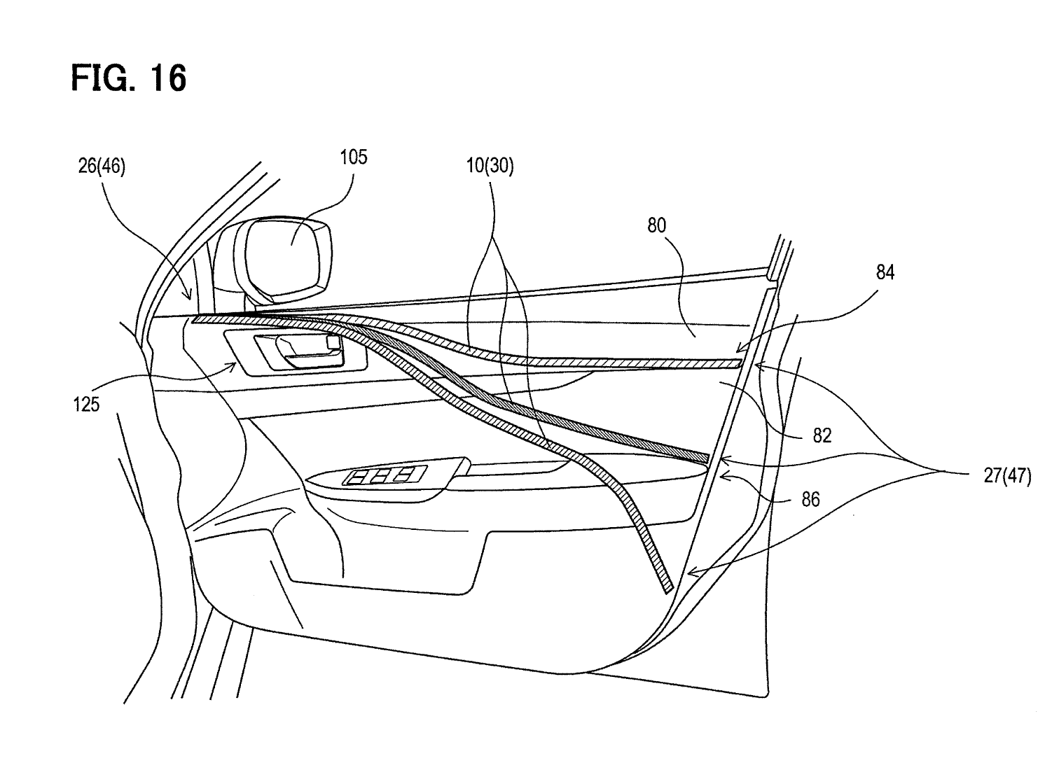

In such cases, the arrangement position of the rear end 28 (48) of the light emitting unit 10, 30 may be at a junction 84 of two door trims 80 and 82 of the front door, at a top end 86 of the arm rest provided in the front door, or at a position lower in the vehicle height direction than the top end 86 of the arm rest, as in FIG. 16.

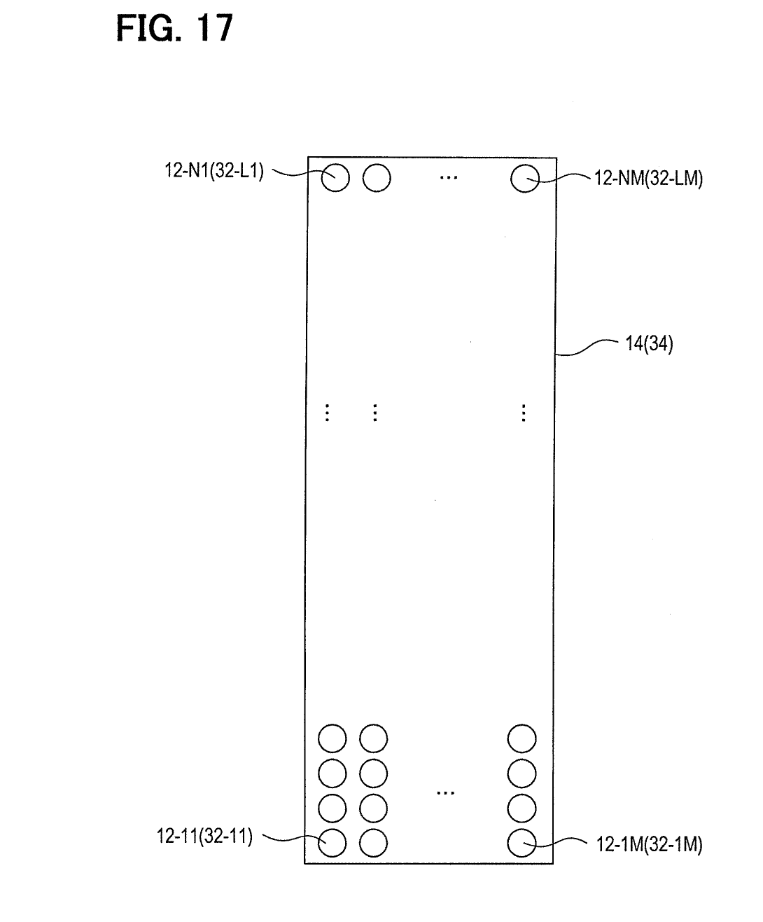

In addition, the light emitting substrate 14, 34 in present disclosure may be a substrate on which several light emitting elements 12, 32 are arranged as a matrix form of N (or L)×M, wherein N (L) is an integer equal to or greater than two (2) and M is an integer equal to or greater than two (2), as in FIG. 17. That is, the light emitting unit 10, 30 in present disclosure may be formed, either by arranging several light emitting elements 12, 32 in several sting lines, or by providing a display apparatus such as a liquid crystal display.

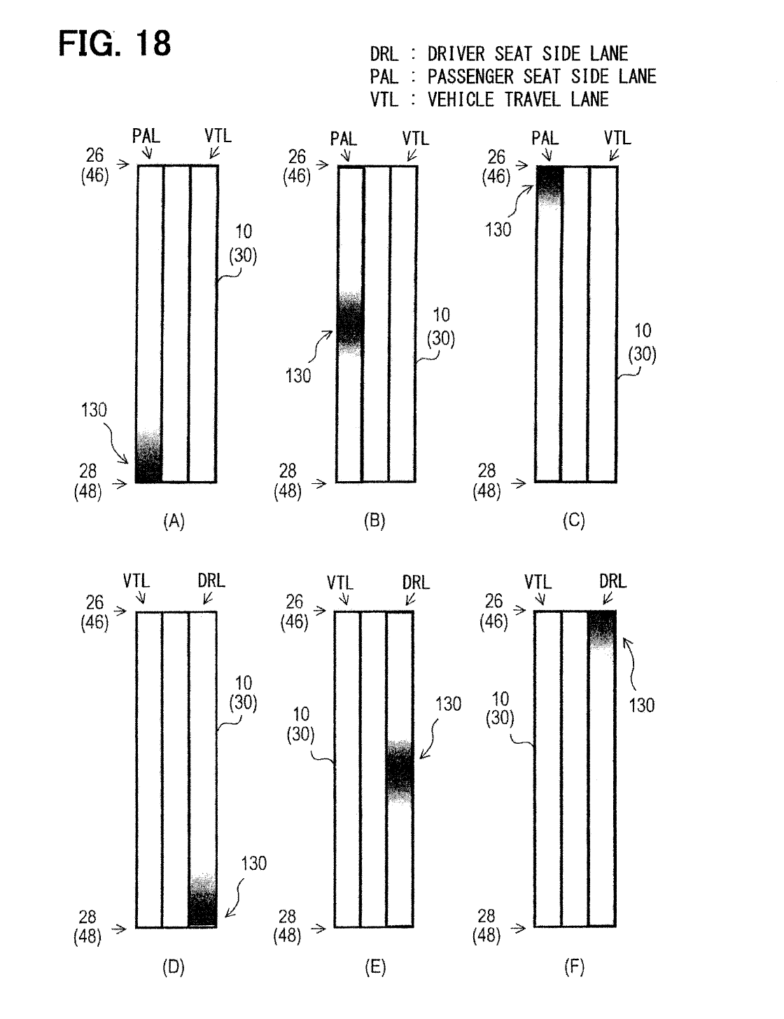

When the light emitting unit 10, 30 is formed as the just above, the third light emitting mode may be provided by the light emitting unit 10 and the light emitting unit 30, respectively, so as to illustrate the relative position relation of the vehicle and the specific object. For instance, when a specific object approaches from the side of the front-passenger seat of the vehicle, the light emitting target 130 may be assigned to the light emitting elements 12, 32 located on the side of the front-passenger seat, as in (A), (B), and (C) of FIG. 18. In contrast, when a specific object approaches from the side of the driver seat of the vehicle, the light emitting target 130 may be assigned to the light emitting elements 12, 32 corresponding to the side of the driver seat, as in (D), (E), and (F) of FIG. 18.

Note that (A)-(C) of FIG. 18 illustrate the light emitting target 130 in time series. In (A) of FIG. 18, the light emitting target 130 corresponds to the group of light emitting elements arranged adjacent to the rear end 28, 48. In (B) and (C) of FIG. 18, the light emitting target 130 moves towards the front end 26, 46 with the lapse of time.

Further, (D), (E), and (F) of FIG. 18 illustrate the light emitting target 130 in time series. In (D) of FIG. 18, the light emitting target 130 corresponds to the group of light emitting elements arranged adjacent to the rear end 28, 48. In (E) and (F) of FIG. 18, the light emitting target 130 moves towards the front end 26, 46 with the lapse of time.

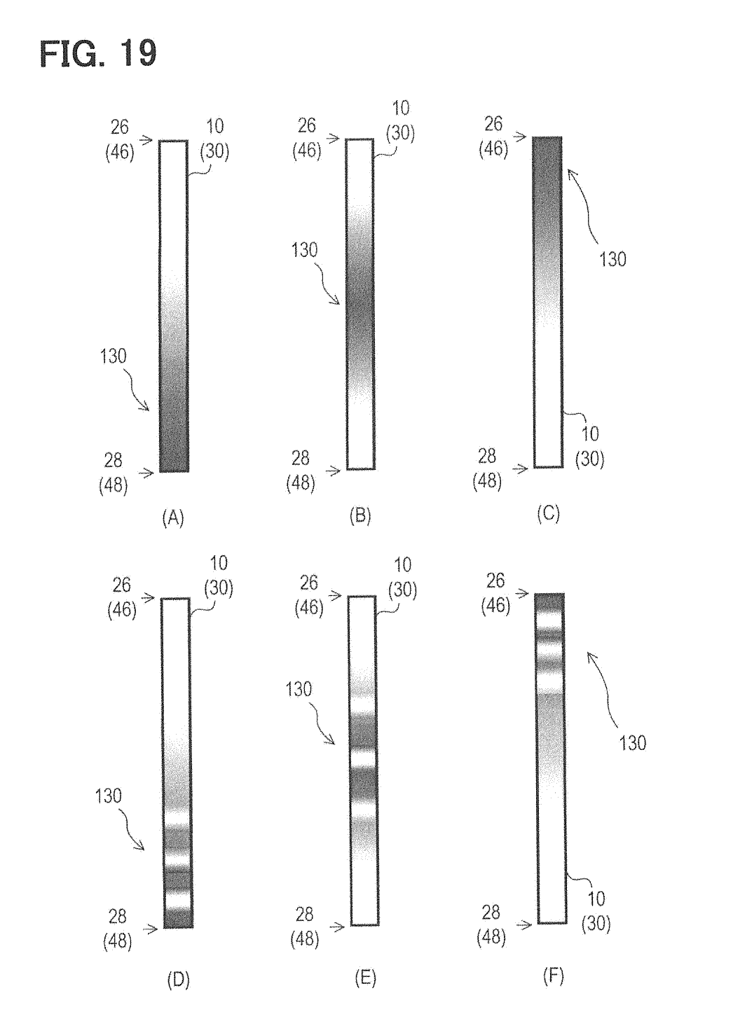

In addition, the third light emitting mode according to the present disclosure may design the arrangement pattern of the light emitting elements 12, 32 included in the light emitting target 130 depending on the degree in the approach of a specific object towards the vehicle. If the degree in the approach is low (i.e., if the relative distance of the vehicle with the specific object is great), the light emitting target 130 may be assigned to the group of the light emitting elements 12, 32 arranged successively, as in (A), (B), and (C) of FIG. 19. In contrast, if the degree in the approach is high (i.e., if the relative distance of the vehicle with the specific object is small), the light emitting target 130 may be assigned to a striped arrangement pattern removing part of the light emitting elements 12, 32 from the group of the light emitting elements 12, 32 arranged successively, as in (D), (E), and (F) of FIG. 19.

Note that (A) to (C) of FIG. 19 illustrate the light emitting target 130 including the group of light emitting elements 12, 32 arranged successively in time series. In (A) of FIG. 19, the light emitting target 130 corresponds to the group of light emitting elements arranged adjacent to the rear end 28, 48. In (B) and (C) of FIG. 19, the light emitting target 130 moves towards the front end 26, 46 with the lapse of time.

Note that (D), (E), and (F) of FIG. 19 illustrate the light emitting target 130 as a striped matrix pattern in time series. In (D) of FIG. 19, the light emitting target 130 is located adjacent to the rear end 28, 48. In (E) and (F) of FIG. 19, the light emitting target 130 moves towards the front end 26, 46 with the lapse of time.

Furthermore, the eye-catching target in the above embodiment assumes a “line marked on road” 100, a rearview mirror 105 provided to the vehicle, and a projection portion 110 on which images from a head up display mounted in the vehicle are projected. The eye-catching target in the present disclosure is not limited thereto. For example, the eye-catching target may assume a known electronic mirror, or various meters or indicators in the instrument panel.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. An information providing apparatus in a vehicle, cooperating with a light emitting unit including a plurality of light emitting elements that are arranged in at least one string line on a vehicle-interior side of a door of the vehicle,
the information providing apparatus comprising:
an information acquisition section that acquires repeatedly situation information including a peripheral situation that indicates a situation on a peripheral region surrounding the vehicle; and
a light emitting control section that controls the light emitting unit based on the situation information acquired by the information acquisition section,
wherein the light emitting control section controls the light emitting unit so that the light emitting unit emits light in a light emitting mode associated with an acquired peripheral situation that is the peripheral situation indicated by the situation information acquired by the information acquisition section.

2. The information providing apparatus according to claim 1, wherein:
the information acquisition section acquires repeatedly the situation information including, as the peripheral situation, a specific object situation indicating presence or absence of a specific object on the peripheral region surrounding the vehicle; and
the light emitting control section
controls the light emitting unit to emit light in a first light emitting mode that is previously specified when the specific object situation fails to indicate the presence of the specific object, and
controls the light emitting unit to emit light in a second light emitting mode that is different from the first light emitting mode when the specific object situation indicates the presence of the specific object.

3. The information providing apparatus according to claim 2, wherein:
the information acquisition section acquires, as one of the peripheral situation, a direction indication information that indicates a course that the vehicle is scheduled to travel; and
the light emitting control section controls the light emitting unit to emit light in a third light emitting mode that is different from each of the first light emitting mode and the second light emitting mode when the specific object situation indicates the presence of the specific object and, simultaneously, the direction indication information indicates the course that is towards a direction in which the vehicle approaches the specific object.

4. The information providing apparatus according to claim 2, wherein:
the specific object situation includes a physical quantity of the specific object that includes at least one of (i) a relative position of the specific object with the vehicle, (ii) a relative velocity of the specific object with the vehicle, and (iii) a magnitude of the specific object; and
the light emitting control section controls the light emitting unit to change a light emitting state of at least one of the light emitting elements depending on the physical quantity of the specific object.

5. The information providing apparatus according to claim 4, wherein:
the light emitting unit is provided in each of a door on a side of a front-passenger seat and a door on a side of a driver seat; and
the light emitting control section
controls the light emitting unit in the door on the side of the front-passenger seat when the specific object is existing closer to the front-passenger seat than to the driver seat, and
controls the light emitting unit in the door on the side of the driver seat when the specific object is existing closer to the driver seat than to the front-passenger seat.

6. The information providing apparatus according to claim 5, further comprising:
an occupant information acquisition section that acquires occupant information indicating presence or absence of an occupant sitting on the front-passenger seat,
wherein when the occupant information acquired by the occupant information acquisition section indicates the presence of the occupant sitting, the light emitting control section controls at least the light emitting elements on the side of the front-passenger seat arranged within a field of view from an eye-point on the driver seat during driving.

7. The information providing apparatus according to claim 1, wherein
the light emitting control section controls the light emitting unit in the light emitting mode associated with the acquired peripheral situation by controlling at least one of a switchover between turning on and turning off of the light emitting elements, a color in light emitted by the light emitting elements turned on, an intensity of light emitted by the light emitting elements turned on, and a time length during turning on of the light emitting elements.

8. The information providing apparatus according to claim 1, wherein
the string line of the light emitting elements included in the light emitting unit has a front end that is closer to a front portion of the vehicle; and
the front end of the light emitting unit is positioned to be higher than a handle of the door in a vehicle height direction.
